(19) United States
(12) Patent Application Publication
(10) Pub. No.: US 2016/0282957 A1
(43) Pub. Date: Sep. 29, 2016

(54) KEYBOARD OUTPUT SETTING SYSTEM AND METHOD

(71) Applicants: SHENZHEN FUTAIHONG PRECISION INDUSTRY CO., LTD., Shenzhen (CN); FIH (HONG KONG) LIMITED, Kowloon (HK)

(72) Inventors: MAN-LING LIU, Shenzhen (CN); CHU-JIE LI, Shenzhen (CN)

(21) Appl. No.: 14/871,026

(22) Filed: Sep. 30, 2015

(30) Foreign Application Priority Data
Mar. 23, 2015 (CN) 201510126883.5

(51) Int. Cl. G06F 3/023; G06F 3/0482; G06F 3/0484

(52) U.S. Cl. CPC G06F 3/0238; G06F 3/04842; G06F 3/0482; G06F 3/04847

(57) ABSTRACT

A computer-implemented method of an electronic device is disclosed. The electronic device includes a keyboard capable of displaying an output of each key. The method includes controlling the keyboard to display an initial keyboard, displaying a plurality of keyboard types for the user to select, receiving a selected keyboard type according to a selection of the user, and making the keyboard to display and output the selected type keyboard, switching the keyboard between different keyboard types, and switching the keyboard form a normal mode to a shortcut key mode.

### FIELD

The subject matter herein generally relates to keyboard output setting systems and methods, and particularly to a keyboard output setting system and method capable of defining an output of each key.

### BACKGROUND

An electronic device such as a mobile phone is generally equipped with a keyboard configured for inputting information. The keyboard can be configured based on the region in which the keyboard is used. For example, keyboards can have a QWERTY arrangement is made for North America. Similarly, a keyboard configured for the German market can have a QWERTZ arrangement. The keyboards for the various regions are fixed based on the intended destination.

### BRIEF DESCRIPTION OF THE DRAWINGS

Implementations of the present technology will now be described, by way of example only, with reference to the attached figures, wherein:

FIG. 1 is a block diagram of one embodiment of an electronic device including a keyboard output setting system

FIG. 2 is a diagrammatic view of one embodiment of an initial keyboard displayed by a keyboard of the electronic device of FIG. 1.

FIG. 3 is a diagrammatic view of one embodiment of a double character keyboard displayed by the keyboard of the electronic device of FIG. 1.

FIG. 4 is a diagrammatic view of one embodiment of a single character keyboard displayed by the keyboard of the electronic device of FIG. 1.

FIG. 5 is a diagrammatic view of one embodiment of the keyboard of the electronic device of FIG. 1 switched to a shortcut key mode.

FIG. 6 is a diagrammatic view of one embodiment of the keyboard of the electronic device of FIG. 1, whose transparency is zero.

FIG. 7 is a flowchart of one embodiment of a keyboard setting method using the keyboard output setting system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series and the like.

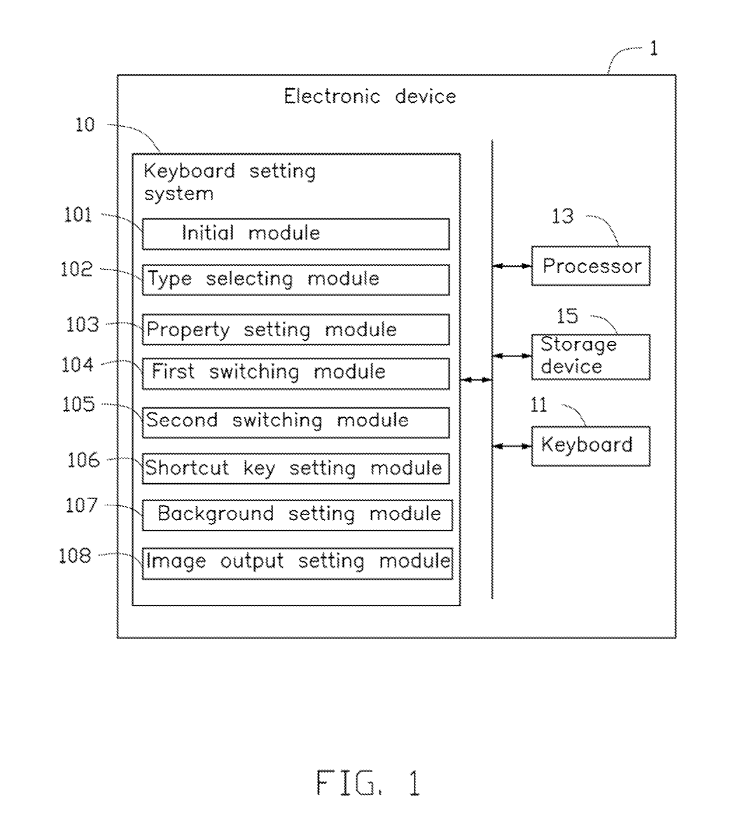

FIG. 1 is a block diagram of one embodiment of an electronic device 1 including a keyboard output setting system 10. The electronic device 1 further includes a keyboard 11. The keyboard 11 can be a physical keyboard which can display outputs hereof. The output of the keyboard 11 is defined as one or more characters or image associated with respective keys. The keyboard 11 include a plurality of keys, each key can display one or more characters. In this exemplary embodiment, the keyboard 11 can include a plurality of transparent keys and a display assembly positioned below the transparent keys. The display assembly can display the one or more characters of each key. The display assembly is configured to display a plurality of characters, each of which are visible through a respective one of the plurality of keys. In this exemplary embodiment, the electronic device 1 can be a computer, a mobile phone and other electronic device.

The electronic device 1 includes a storage device 13 providing one or more memory functions, and at least one processor 15. In at least one embodiment, the keyboard output setting system 10 may include computerized instructions in the form of one or more programs, which are stored in the storage device 13 and executed by the at least one processor 15 to perform operations of the electronic device 1.

The storage device 13 stores one or more programs, such as programs of the operating system, other applications of the electronic device 1, a plurality of images, which can be set as the outputs of the keys. In some embodiments, the storage device may include a memory of the electronic device 1 and/or an external storage card, such as a memory stick, a smart media card, a compact flash card, or any other type of memory card. FIG. 1 illustrates only one example of the electronic device 1 that may include more or fewer components than as illustrated, or have a different configuration of the various components.

In at least one embodiment, the keyboard output setting system 10 may include one or more modules, for example, an initial module 101, a type selecting module 102, a property setting module 103, a first switching module 104, a second switching module 105, a shortcut key setting module 106, a background setting module 107, and an image output setting module 108. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

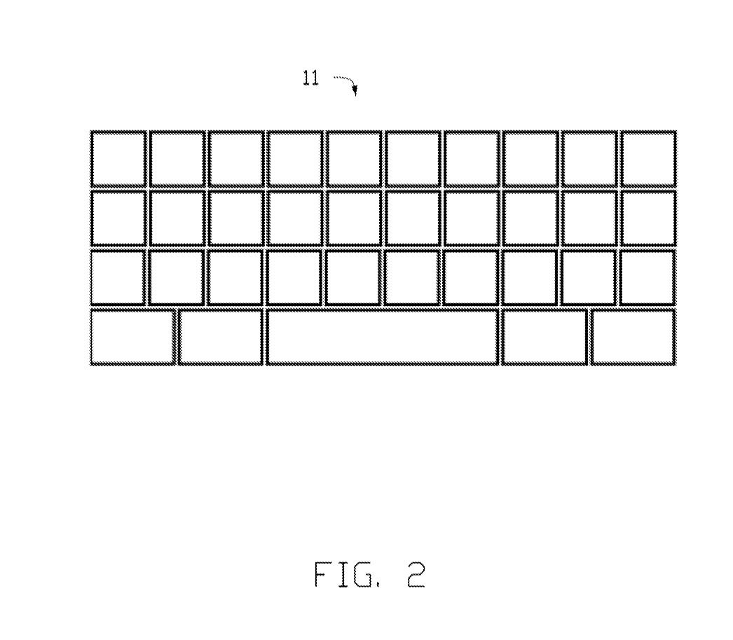

The initial module 101 can be configured to control the keyboard 11 to display an initial keyboard thereby initialing the keyboard 11 so that an user can conveniently set the keyboard 11 thereafter. FIG. 2 illustrates that, in this embodiment, the initial keyboard is defined as a blank keyboard having a white color and a white ground. In other embodiment, the initial keyboard can be also a blank keyboard having other color such as red, green, etc and other ground such as an image ground.

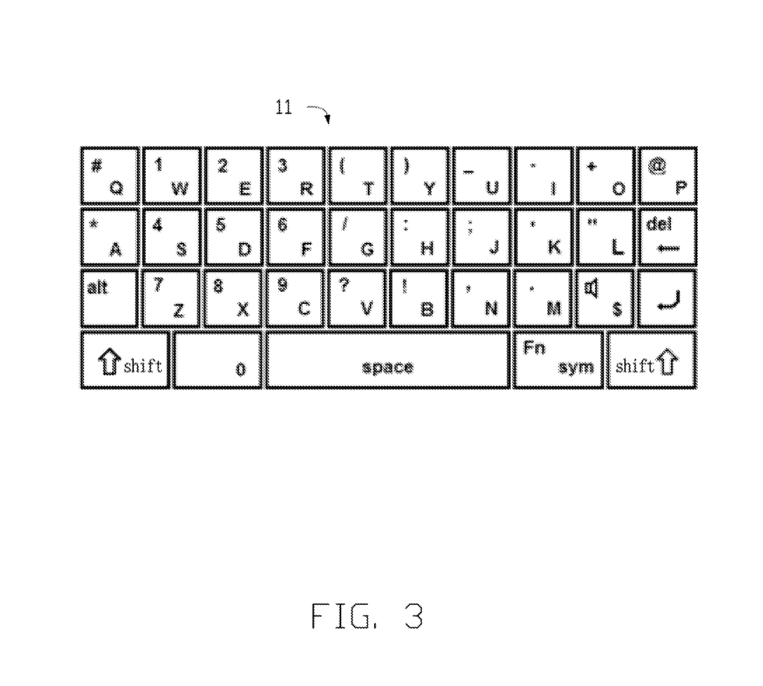

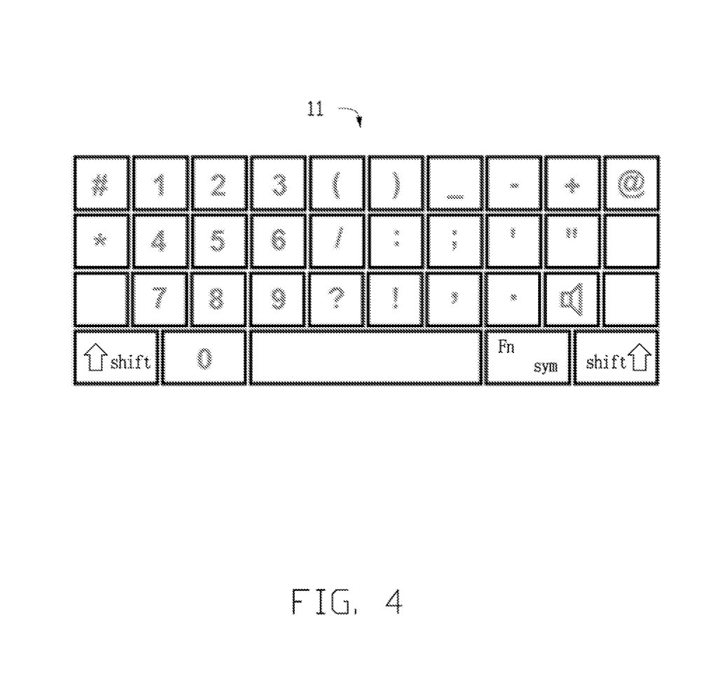

The type selecting module 102 can be configured to control the keyboard 11 to display a plurality of keyboard types for the user to select. The type selecting module 102 can be configured to receive a selected keyboard type according to a selection of the user and control the keyboard 11 to display the selected type keyboard and output the selected type keyboard. In this exemplary embodiment, the plurality of keyboard types includes a double character keyboard as shown in FIG. 3 and a single character keyboard as shown in FIG. 4. The single character keyboard includes a Chinese full keyboard, a digital keyboard, and an alphabetical keyboard.

The property setting module 103 can be configured to receive settings of properties of the output of each key from the user and controls each key to display and output the output of each key according to the set properties. In this exemplary embodiment, the set properties includes position, font, and color of the output and a clicking effect.

The first switching module 104 can be configured to control the key of the double character keyboard type keyboard 11 to switch between different characters according to a first switching operation of the user. The first switching module 104 also can be configured to control the keyboard 11 to switch between different single character keyboard types, according to the first switching operation of the user. In this exemplary embodiment, the first switching module 104 controls the key to switch between a first character shown on a up left corner and a second character shown on a bottom right corner or to switch between the Chinese full keyboard, the digital keyboard, and the alphabetical keyboard. In this exemplary embodiment, the first switching operation is defined as simultaneously pressing a Shift key and an other key except for an Sym/Fn key.

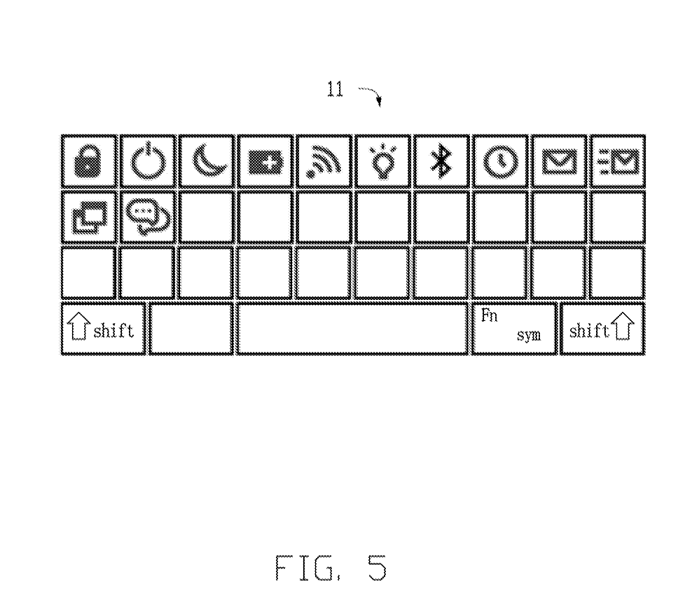

The second switching module 104 can be configured to control the keyboard 11 to switch from a normal mode to a shortcut key mode, according to a second switching operation of the user. In this exemplary embodiment, the shortcut function of each key is preset. FIG. 5 illustrates that the keyboard 11 is switched to the shortcut key mode. Each key displays an image corresponding to a corresponding shortcut function and can be pressed to activate the corresponding shortcut function. The second switching module 105 also controls the keyboard 11 to switch from the shortcut key mode back to the normal mode, according to a recovery operation of the user. In this exemplary embodiment, the second switching operation is defined as simultaneously pressing the Shift key and the Sym/Fn key. The recovery operation is defined as a double-click of the Sym/Fn key.

The shortcut key setting module 106 can be configured to set the shortcut function corresponding to each key according to a user-defined operation of user. In this exemplary embodiment, the shortcut function maybe a control function, an editing function, and a touch function. The control function may include taking photos, locking screen, activating Bluetooth, or powering off. The editing function may include copy, paste, preservation, and screenshots. The touch function is defined as pressing the key to realize a touch function on a screen including some point click, click, sliding, multi-point sequence click or click at the same time, etc.

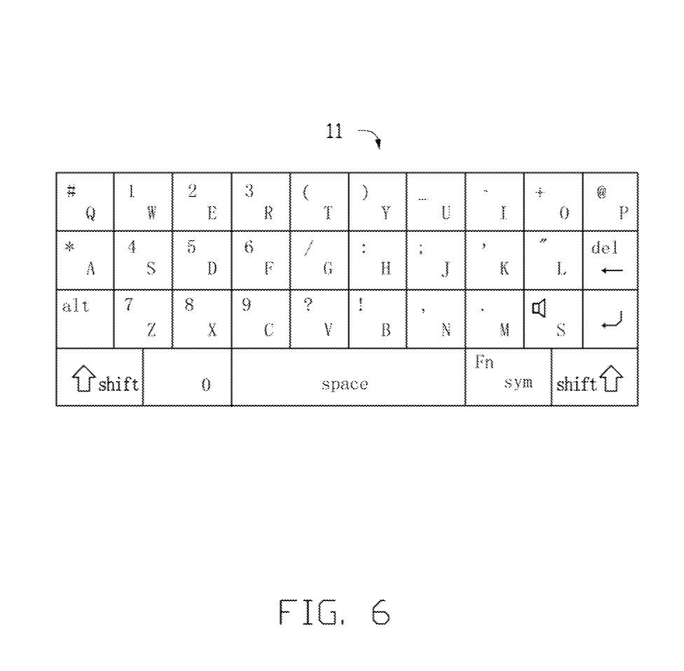

The background setting module 107 can be configured to set a background image of the keyboard according to a background setting operation of the user. In this exemplary embodiment, the background setting operation is defined as selecting one image from the image preset in the storage 13 or reading an image from a preset path, and displaying the selected image. In other exemplary embodiment, the background setting module 107 further sets transparency of the background image of the keyboard 11, according to the background setting operation of the user. For example, FIG. 6 illustrates that the transparency of the background image of the keyboard 11 is set as zero.

The image output setting module 108 can be configured to set an image as the output of the key of the keyboard according to an image output setting operation of the user. In this exemplary embodiment, the image output setting operation is defined as selecting one image from the image preset in the storage device 13 or reading an image from a preset path as the output image.

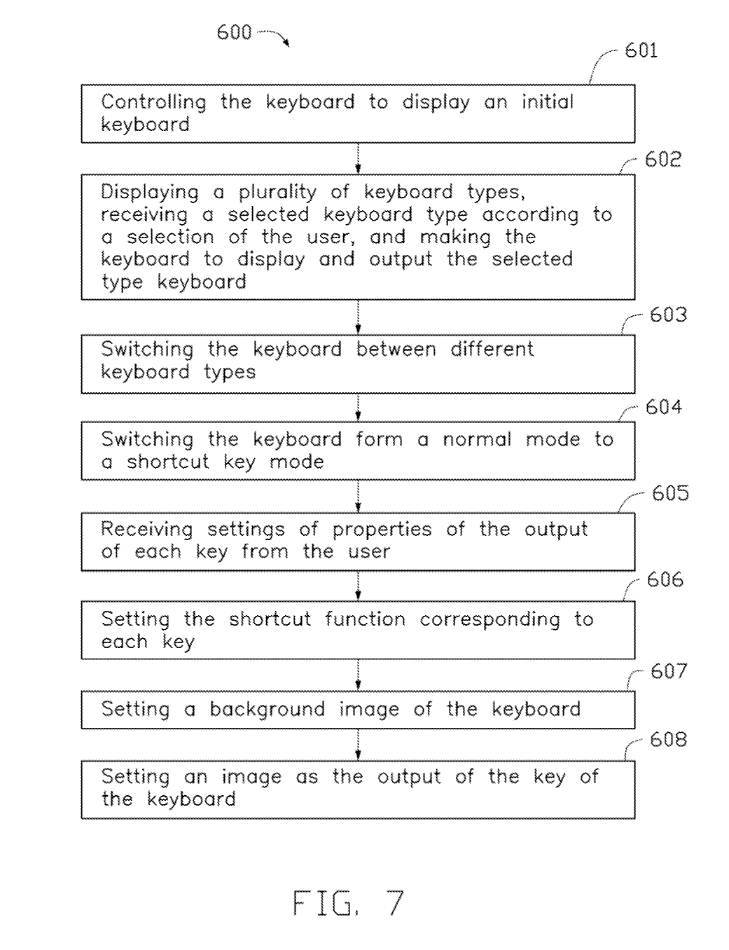

FIG. 7 is a flowchart in accordance with a first embodiment. The example method 600 is provided by way of example, as there are a variety of ways to carry out the method. The method 600 described below can be carried out using the configurations illustrated in FIG. 1, for example, and various elements of these figures are referenced in explaining example method 600. Each block shown in FIG. 7 represents one or more processes, methods or subroutines, carried out in the exemplary method 600. Furthermore, the illustrated order of blocks is by example only and the order of the blocks can change according to the present disclosure. Additional blocks may be added or fewer blocks may be utilized, without departing from this disclosure. The exemplary method 600 can begin at block 601.

At block 601, the initial module 101 controls the keyboard 11 to display an initial keyboard thereby initialing the keyboard 11 so that an user can conveniently set the keyboard 11 thereafter. FIG. 2 illustrates that, in this embodiment, the initial keyboard is defined as a blank keyboard having a white color and a white ground.

At block 602, the type selecting module 102 controls the keyboard 11 to display a plurality of keyboard types for the user to select. The type selecting module 102 receives a selected keyboard type according to a selection of the user and controls the keyboard 11 to display the selected keyboard type and output information as selected keyboard type. In this exemplary embodiment, the plurality of keyboard types includes a double character keyboard as shown in FIG. 3 and a single character keyboard as shown in FIG. 4. The single character keyboard includes at least one of a Chinese full keyboard, a digital keyboard, or an alphabetical keyboard.

At block 603, the property setting module 103 receives settings of properties of the output displayed and output by each key from the user and controls each key to display and output the output of each key according to the set properties. In this exemplary embodiment, the set properties includes position, font, and color of the output and a clicking effect.

At block 604, the first switching module 104 controls the key of the double character keyboard type keyboard 11 to switch between different characters. The first switching module 104 also controls the keyboard 11 to switch between different single character keyboard types, according to a first switching operation of the user. In this exemplary embodiment, the first witching module 104 controls the key to switch between a first character shown on a up left corner and a second character shown on a bottom right corner or to switch between the Chinese full keyboard, the digital keyboard, and the alphabetical keyboard. In this exemplary embodiment, the first switching operation is defined as simultaneously pressing a Shift key and an other key except for an Sym/Fn key.

At block 605, the second switching module 104 controls the keyboard 11 to switch from a normal mode to a shortcut key mode, according to a second switching operation of the user. In this exemplary embodiment, the shortcut function of each key is preset. FIG. 5 illustrates that the keyboard 11 is switched to the shortcut key mode. Each key displays an image corresponding to a corresponding shortcut function and can be pressed to activate the corresponding shortcut function. The second switching module 105 also controls the keyboard 11 to switch from the shortcut key mode back to the normal mode, according to a recovery operation of the user. In this exemplary embodiment, the second switching operation is defined as simultaneously pressing the Shift key and the Sym/Fn key. The recovery operation is defined as a double-click of the Sym/Fn key.

At block 606, the shortcut key setting module 106 sets the shortcut function corresponding to each key according to a user-defined operation of user. In this exemplary embodiment, the shortcut function maybe a control function, a editing function, and a touch function. The control function may include taking photos, locking screen, activating Bluetooth, or powering off. The editing function may include copy, paste, preservation, and screenshots. The touch function is defined as pressing the key to realize a touch function on a screen including some point click, click, sliding, multi-point sequence click or click at the same time, etc.

At block 607, the background setting module 107 sets the background image of the keyboard according to a background setting operation of the user. In this exemplary embodiment, the background setting operation is defined as selecting one image from the image preset in the storage device 13 or reading an image from a preset path, and displaying the selected image. In other exemplary embodiment, the background setting module 107 further sets transparency of the background image of the keyboard 11, according to the background setting operation of the user. For example, FIG. 6 illustrates that the transparency of the background image of the keyboard 11 is set as zero.

At block 608, the image output setting module 108 sets an image as the output of the key of the keyboard according to an image output setting operation of the user. In this exemplary embodiment, the image output setting operation is defined as selecting one image from the image preset in the storage 13 or reading an image from a preset path as the output image.

Therefore, the user can define the outputs of the keyboard 11 according to their own habits through above-mentioned steps. The output of each key is changeable and flexible.

The embodiments shown and described above are only examples. Many details are often found in the art such as the other features. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A computer-implemented method of setting keyboard output of an electronic device, the electronic device comprising a keyboard configured to display one or more characters associated with respective keys of the keyboard, the method comprising:
controlling the keyboard to display an initial keyboard;
displaying a plurality of keyboard types for the user to select;
receiving a selected keyboard type according to a selection of the user; and
controlling the keyboard to display the selected type keyboard;
switching the keyboard between different keyboard types; and
switching the keyboard form a normal mode to a shortcut key mode.

2. The method according to claim 1, further comprising:
receiving settings of properties of the output of each key from the user and controlling each key to display and output the output.

3. The method according to claim 1, further comprising:
setting the shortcut function corresponding to each key according to a user-defined operation of an user, wherein the shortcut function comprises a control function, an editing function, and a touch function.

4. The method according to claim 1, further comprising:
setting a background image of the keyboard according to a background setting operation of the user, wherein the background setting operation is defined as one of selecting one image from images preset in an storage device and reading an image from a preset path.

5. The method according to claim 1, further comprising:
setting an image as the output of the key of the keyboard according to an image output setting operation of the user, wherein the image output setting operation is defined as one of selecting one image from the image preset in the storage device and reading the image from the preset path.

6. An electronic device, comprising:
a keyboard capable of displaying an output of each key;
a storage device;
at least one processor; and
one or more modules that are stored in the storage device and executed by the at least one processor, the one or more modules comprising:
an initial module controlling the keyboard to display an initial keyboard;
a type selecting module displaying a plurality of keyboard types for the user to select, receiving a selected keyboard type according to a selection of the user, and making the keyboard to display and output the selected type keyboard;
a first switching module switching the keyboard between different keyboard types; and
a second switching module switching the keyboard form a normal mode to a shortcut key mode.

7. The electronic device according to claim 6, further comprising a property setting module, wherein the property setting module receives settings of properties of the output of each key from the user and controlling each key to display and output the output.

8. The electronic device according to claim 6, further comprising a shortcut key setting module, wherein the shortcut key setting module sets the shortcut function corresponding to each key according to a user-defined operation of an user, the shortcut function comprises a control function, an editing function, and a touch function.

9. The electronic device according to claim 6, further comprising a background setting module, wherein the background setting module sets a background image of the keyboard according to a background setting operation of the user, wherein the background setting operation is defined as one of selecting one image from images preset in an storage device and reading an image from a preset path.

10. The electronic device according to claim 6, further comprising an image output setting module, wherein the image output setting module sets an image as the output of the key of the keyboard according to an image output setting operation of the user, wherein the image output setting operation is defined as one of selecting one image from the images preset in the storage device and reading the image from the preset path.

11. A non-transitory storage medium having stored instructions that, when executed by a processor of an electronic device, causes the electronic device to perform a method for setting outputs of a keyboard of the electronic device comprising: a keyboard capable of displaying an output of each key, the method comprising:
controlling the keyboard to display an initial keyboard;
displaying a plurality of keyboard types for the user to select, receiving a selected keyboard type according to a selection of the user, and making the keyboard to display and output the selected type keyboard;
switching the keyboard between different keyboard types; and
switching the keyboard form a normal mode to a shortcut key mode.

12. The non-transitory storage medium according to claim 11, further comprising:
receiving settings of properties of the output of each key from the user and controlling each key to display and output the output.

13. The non-transitory storage medium according to claim 11, further comprising:
setting the shortcut function corresponding to each key according to a user-defined operation of an user, wherein the shortcut function comprises a control function, an editing function, and a touch function.

14. The non-transitory storage medium according to claim 11, further comprising:
setting a background image of the keyboard according to a background setting operation of the user, wherein the background setting operation is defined as one of selecting one image from images preset in an storage device and reading an image from a preset path.

15. The non-transitory storage medium according to claim 11, further comprising:
setting an image as the output of the key of the keyboard according to an image output setting operation of the user, wherein the image output setting operation is defined as one of selecting one image from the images preset in the storage device and reading the image from the preset path.
